(19) United States
(12) Patent Application Publication
(10) Pub. No.: US 2023/0030880 A1
(43) Pub. Date: Feb. 2, 2023

(54) DETERMINISTIC EXCEPTION HANDLING FOR ITEM IDENTITY FEDERATION AND VISIBILITY AS A SERVICE

(71) Applicant: Cisco Technology, Inc., San Jose, CA (US)

(72) Inventors: Marcelo YANNUZZI, Vufflens-La-Ville (CH); Lionel FLORIT, Greenbrae, CA (US); Joel Abraham OBSTFELD, Bushey (GB); Chee Wai FOONG, San Jose, CA (US)

(21) Appl. No.: 17/390,465

(22) Filed: Jul. 30, 2021

(51) Int. Cl. G06Q 10/08; G06Q 10/00

(52) U.S. Cl. CPC G06Q 10/0875; G06Q 10/083; G06Q 10/20; G06Q 50/28

(57) ABSTRACT

According to one or more embodiments of the disclosure, a device obtains, from a service connector of a first organization, event data for an event regarding shipment of one or more physical assets between organizations. The device identifies, based on the event data, a response policy associated with the event. The device identifies, based on the response policy, a second organization that is affected by the event. The device sends a notification regarding the event to a service connector of the second organization to initiate a corrective action for the event.

### TECHNICAL FIELD

The present disclosure relates generally to computer networks, and, more particularly, to deterministic exception handling for item identity federation and visibility as a service.

### BACKGROUND

A supply chain may be subject to a variety of exceptions (e.g., quality issues, delays/closures, temperature violations affecting items either in stock or in transit, etc.) and across a variety of siloed systems. For instance, assume that there are multiple entities involved in the supply chain (e.g., a supplier, an owner of the shipped goods and a set of partners). Each of these may have their own corresponding systems, such as the supplier's enterprise system, the partners' management systems, etc. Now, assume that the supplier detects a quality issue in one of its components. When this happens, the supplier notifies the issue to the owner. This is usually referred to as a Supplier Quality Alert (SQA), and it would typically affect goods that were already shipped and are now under the custody of the owner and its partners. As a result, the owner needs to contact its partners to identify the number of parts affected and their corresponding location.

Today, when such issues occur, manual interactions take place between the supply chain entities in order to determine the level of impact. Emails will be sent, phone calls will be made so that information can be gather, remedial actions planned and then executed—but time is a critical factor. The time taken for each of the partners to respond to request for information can be lengthy, not just for obtaining and reporting back, but even for acknowledging the initial request since these interactions typically rely on human-to-human engagement.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example network;

FIG. 2 illustrates an example network device/node;

FIG. 3 illustrates an example identity federation and visibility service;

FIG. 4 illustrates an example architecture for an identity federation and visibility service;

FIG. 5 illustrates an example exception handling service for an identity federation and visibility service;

FIG. 6 illustrates an example architecture for an exception handling service for an identity federation and visibility service;

FIG. 7 illustrates an example flow diagram for an exception handling service for an identity federation and visibility service;

FIG. 8 illustrates an example flow diagram for an exception handling service that includes a finite state machine for an identity federation and visibility service; and

FIG. 9 illustrates an example simplified procedure for providing deterministic exception handling for item identity federation and visibility as a service.

### DESCRIPTION OF EXAMPLE EMBODIMENTS

### Overview

According to one or more embodiments of the disclosure, a device obtains, from a service connector of a first organization, event data for an event regarding shipment of one or more physical assets between organizations. The device identifies, based on the event data, a response policy associated with the event. The device identifies, based on the response policy, a second organization that is affected by the event. The device sends a notification regarding the event to a service connector of the second organization to initiate a corrective action for the event.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications, and others. Other types of networks, such as field area networks (FANs), neighborhood area networks (NANs), personal area networks (PANs), etc. may also make up the components of any given computer network.

In various embodiments, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or Powerline Communication networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Fog computing (also known as edge computing, near edge computing, far edge computing, etc.) is a distributed approach of cloud implementation that acts as an intermediate layer from local networks (e.g., IoT networks) to the cloud (e.g., centralized and/or shared resources, as will be understood by those skilled in the art). That is, generally, fog computing entails using devices at the network edge to provide application is services, including computation, networking, and storage, to the local nodes in the network, in contrast to cloud-based approaches that rely on remote data centers/cloud environments for the services. To this end, a fog node is a functional node that is deployed close to fog endpoints to provide computing, storage, and networking resources and services. Multiple fog nodes organized or configured together form a fog system, to implement a particular solution. Fog nodes and fog systems can have the same or complementary capabilities, in various implementations. That is, each individual fog node does not have to implement the entire spectrum of capabilities. Instead, the fog capabilities may be distributed across multiple fog nodes and systems, which may collaborate to help each other to provide the desired services. In other words, a fog system can include any number of virtualized services and/or data stores that are spread across the distributed fog nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:

1) Links are generally lossy, such that a Packet Delivery Rate/Ratio (PDR) can dramatically vary due to various sources of interferences, e.g., considerably affecting the bit error rate (BER);

2) Links are generally low bandwidth, such that control plane traffic must generally be bounded and negligible compared to the low rate data traffic;

3) There are a number of use cases that require specifying a set of link and node metrics, some of them being dynamic, thus requiring specific smoothing functions to avoid routing instability, considerably draining bandwidth and energy;

4) Constraint-routing may be required by some applications, e.g., to establish routing paths that will avoid non-encrypted links, nodes running low on energy, etc.;

5) Scale of the networks may become very large, e.g., on the order of several thousands to millions of nodes; and

6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

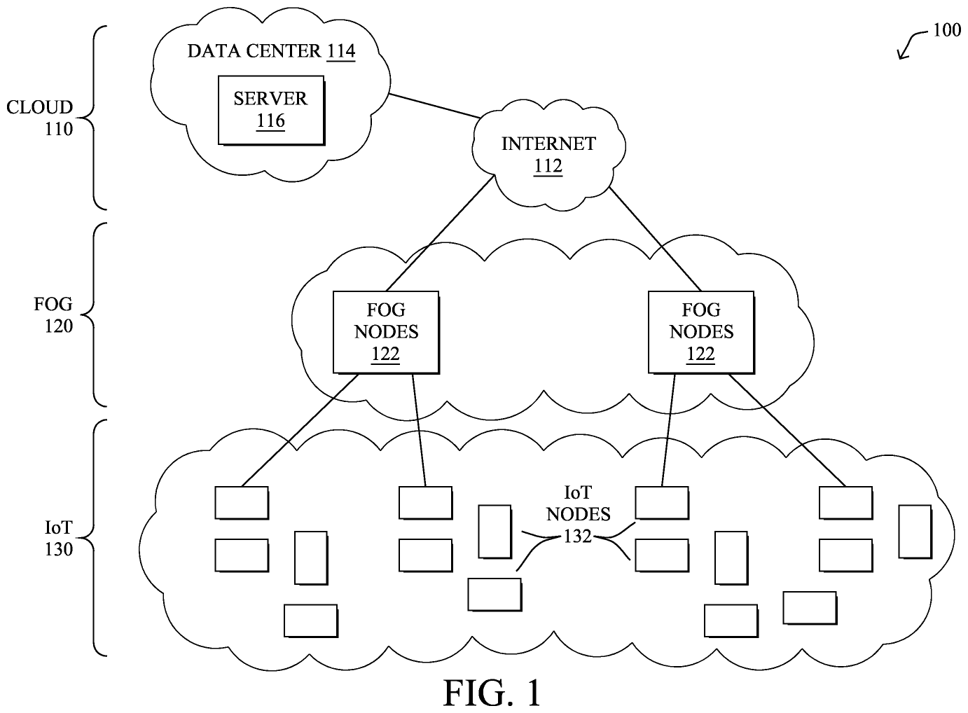

FIG. 1 is a schematic block diagram of an example simplified computer network 100 illustratively comprising nodes/devices at various levels of the network, interconnected by various methods of communication. For instance, the links may be wired links or shared media (e.g., wireless links, powerline communication links, etc.) where certain nodes, such as, e.g., routers, sensors, computers, etc., may be in communication with other devices, e.g., based on connectivity, distance, signal strength, current operational status, location, etc.

Specifically, as shown in the example network 100, three illustrative layers are shown, namely cloud layer 110, fog layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the fog layer 120, various fog nodes/devices 122 (e.g., with fog modules, described below) may execute various fog computing resources on network edge devices, as opposed to datacenter/cloud-based servers or on the endpoint nodes 132 themselves of the IoT device layer 130. For example, fog nodes/devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, powerline communication protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc.), powerline communication protocols, or other shared-media protocols where appropriate. In this context, a protocol consists of a set of rules defining how the nodes interact with each other.

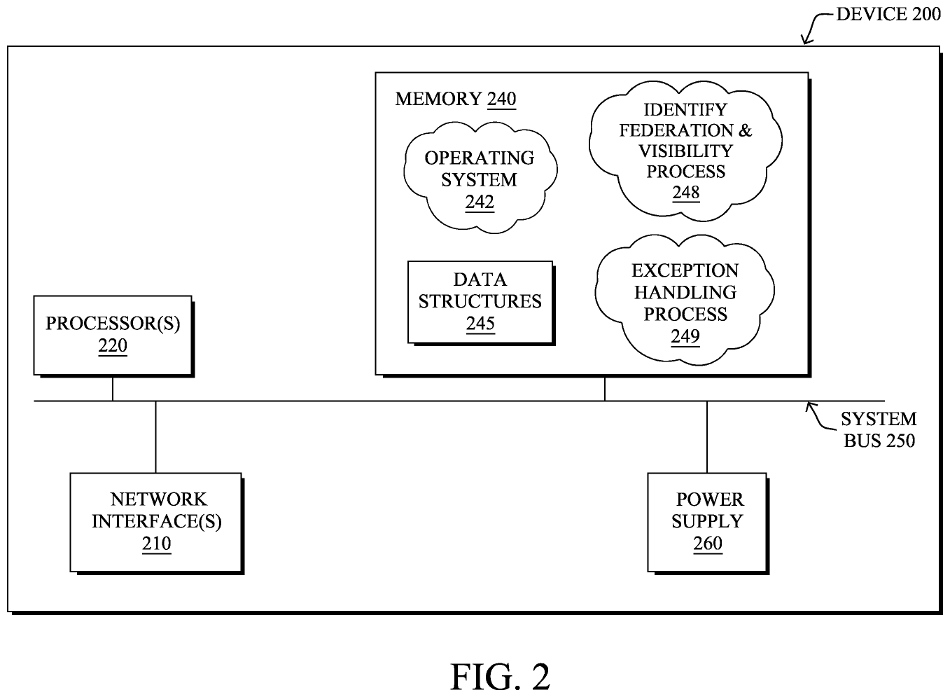

FIG. 2 is a schematic block diagram of an example node/device 200 (e.g., an apparatus) that may be used with one or more embodiments described herein. As shown, device 200 may comprise one or more communication interfaces 210 (e.g., wired, wireless, etc.), at least one processor 220, and a memory 240 interconnected by a system bus 250, as well as a power supply 260 (e.g., battery, plug-in, etc.).

Communication interface(s) 210 may be coupled to processor 220 and include the mechanical, electrical, and signaling circuitry for communicating data over a communication link. To this end, communication interface(s) 210 may be configured to transmit and/or receive data using a variety of different communication protocols, such as TCP/IP, UDP, etc. Note that the device 200 may have multiple different types of communication interface(s) 210, e.g., wireless and wired/physical connections, and that the view herein is merely for illustration.

The memory 240 comprises a plurality of storage locations that are addressable by the processor(s) 220 and the communication interface(s) 210 for storing software programs and data structures associated with the embodiments described herein. The processor 220 may comprise necessary elements or logic adapted to execute the software programs and manipulate the data structures 245. An operating system 242, portions of which are typically resident in memory 240 and executed by the processor(s), functionally organizes the node by, inter alia, invoking network operations in support of software processors and/or services executing on the device. These software processors and/or services may comprise an identity federation and visibility process 248 and an exception handling process 249.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Modern supply chains typically span multiple organizations, such as the shipper of an item, any number of carriers, and the target destination of the item. As the item travels towards its destination, its digital representation may undergo a number of transformations. For instance, the identity of the item under the responsibility of a first carrier is likely to be different than the identity of the same item under the responsibility of a second carrier.

Even within a single organization, the identification of a particular item may vary due to the different technologies that shippers may employ. For instance, an item may be tagged using a barcode, a Quick Response (QR) code, radio frequency identification (RFID) tag, Bluetooth Low Energy (BLE) tag, cellular tag, or the like. It is also quite common for an item to be re-tagged when passing from one carrier to another (e.g., the new carrier puts a new barcode on the item being shipped). In doing so, this effectively changes the digital identity of the item. As a result, supply chains that span multiple organizations often lack end-to-end transparency.

As noted above, visibility represents one of the main areas of focus in supply chains, as they undergo a digital transformation. In general, visibility refers to the ability to answer questions such as the following:
What is this item?
Where is a particular item?
What is the state of a particular item?
Etc.
   Without visibility across the supply chain, it is quite difficult to make informed decisions. Despite this, modern supply chains tend to be fractured in terms of visibility, due to the myriad of organizations that may be involved.

A major challenge in automating end-to-end supply chains is that there is no one-size-fits-all identification technology that has received universal support by the industry. Today, for instance, some products may be tagged with radio frequency identification (RFID) transponders, others may use barcodes. Bluetooth Low Energy (BLE) or alternative technologies in the future, such as ultra-wideband (UWB) or cellular (e.g., 5G) active tags. These technologies have different identity spaces and formats, and many tagged products have different identity providers. For example, the identity of a product while under the responsibility of a first carrier is very likely to be different than the identity of the same product while under the responsibility of a second carrier. In fact, it is quite common for a product to be “re-tagged” when passing from one carrier to another, effectively changing its digital identity.

Even if all the supply chains worldwide would agree upon a single Universally Unique Identifier (UUID) and a common traceability technology, still dealing with different identity providers is unavoidable by the mere construction of the supply chain. For instance, many warehouses receive, store, and ship products manufactured by different entities, and therefore, those products will have different identity providers. In fact, supply chains are inherently federated ecosystems, but their members lack the ability to amalgamate the different identities and identity providers involved in this type of federation.

Accordingly, there is a real-world demand to verify, and attest to, the identity of items that are transported via a (contactless) supply chain across different organizations. One potential approach to achieving this would be to build complex integrations between the systems of two organizations (e.g., a shipper and a carrier). However, this typically requires both organizations to use the same software or for one organization to ‘adapt’ to the system of another organization. Adaptation of a common system is typically not practical, when across an entire supply chain, as there may be many different organizations that have responsibility for an item.

### Item Identity Federation and Visibility as a Service

The techniques herein introduce an item identity federation and visibility service that allows common policy lists to be rendered, automatically, for exchanging data between organizations based on their profiles (e.g., a manufacturer and a warehouse, a transporter and a warehouse, etc.). In some aspects, the techniques herein also allow users to select which information they wish to request from other organizations (e.g., a ‘visibility intent’), as well as the information they would like to publish to other organizations (e.g., a ‘visibility offering’). In further aspects, the techniques herein allow for the automatic matching of visibility policies among organizations: 1.) based on the identification technologies used (e.g., RFID, barcodes, BLE, etc.) and 2.) based on the specified visibility intents and the visibility offerings.

Operationally, the federated identity method introduced herein allow for information about an item to be shared across different organizations, systems, and/or technologies. In such a model, instead of a single identity system being used, requests for verification and/or validation of an identity may be passed to a specified identity provider. Note that prior approaches to this have mainly focused on the authentication and authorization of users or other data consumers. However, the requirements in terms of item identification in a contactless supply chain differ significantly from what these types of approaches offer. For instance, inventory visibility typically entails challenges relating to identification and notification across domains, rather than those relating to authentication or guest network access. Indeed, an RFID interrogator or barcode scanner will not need remote authentication of a passive RFID transponder or barcode, since such a functional requirement does not (currently) exist. Moreover, many of the devices used to tag (and identify) inventory do not need guest/Internet access (e.g., RFID, BLE, barcodes, UWB, etc.).

In addition, simplicity and ease of use is paramount in supply chains. Indeed, the trend in this sector is to increase the level of automation of the large majority of the processes. In so doing, organizations are choosing to lease a significant part of the equipment and infrastructure needed to run the business, rather than purchase such systems themselves. This applies to a wide variety of equipment, ranging from advanced systems such as Automated Mobile Robots (AMRs) and automated forklifts to industrial RFID interrogators, meaning that there is a rapidly increasing number of third-party identities and devices that need to interact with the local communications infrastructures and systems of an organization.

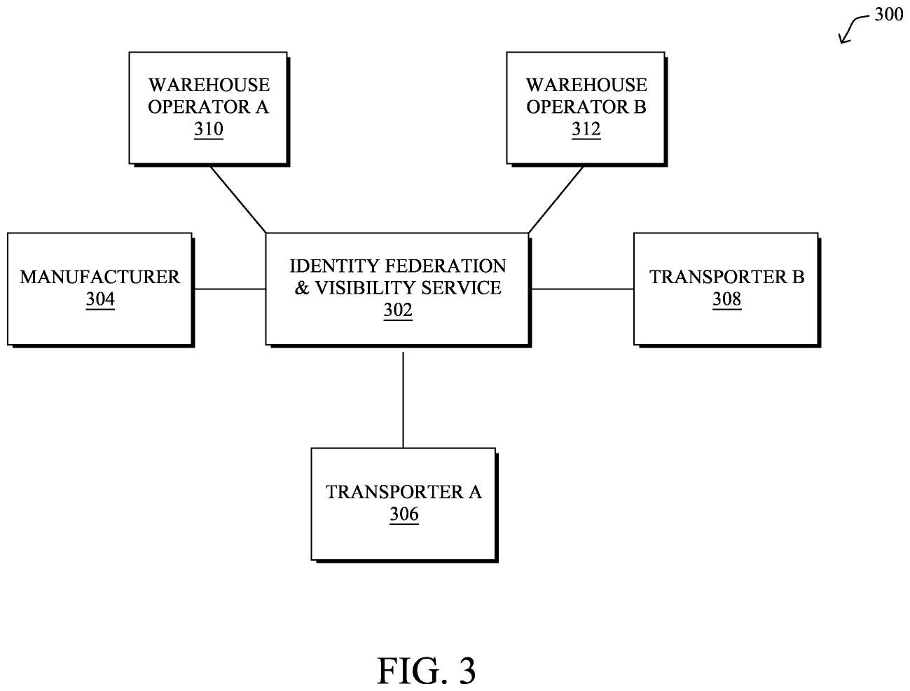

FIG. 3 illustrates an example identity federation and visibility service, according to various embodiments. As shown, system 300 may include an identity federation and visibility service 302 that allows any organization (e.g., a member of a supply chain) to easily initiate an identity federation. For instance, as shown, consider a typical supply chain that involves the following organizations: a manufacturer 304 that ships an item to a destination. During transit, any number of transporters, such as transporters 306-308 (e.g., a first transporter, a second transporter, etc.), may receive, transport, and hand off the item to another organization. In addition, there may be any number of other organizations involved in the supply chain, such as warehouse operators 310-312 (e.g., a first warehouse operator, a second warehouse operator, etc.), that store the shipped item while in transit and/or on delivery.

By way of example, consider the case in which manufacturer 304 is to send an item for delivery to a third-party warehouse operator 312 (e.g., a retailer). To do so, manufacturer 304 may pass the item to transporter 306. In turn, transporter 306 may ship the item and, at some point, deposit the item at a warehouse operated by warehouse operator 310. From there, transporter 308 may pick up the item from the first warehouse and convey it through its own channels until finally delivering the item to its final destination, a warehouse operated by warehouse operator 312.

At the core of system 300 is identity federation and visibility service 302, which may be provided by one or more devices, such as device 200, through the execution of identity federation and visibility process 248. In some instances, identity federation and visibility service 302 may be provided by an organization that differs from those of manufacturer 304, transporters 306-308, warehouse operators 310-312. In other instances, identity federation and visibility service 302 may be provided by any of these organizations.

After creating an identity federation via identity federation and visibility service 302, the creator can invite other organizations to join the federation and start using it. More specifically, the techniques herein allow even non-technically savvy users to create and/or join an identity federation via identity federation and visibility service 302 in a rapid manner. Once established, the identity federation provided by identity federation and visibility service 302 allows the authorized participant organizations to share and view information about the item throughout its traversal of the supply chain.

For instance, assume that each of the organizations 304-312 have registered with identity federation and visibility service 302 and participate in the identity federation of the item shipped by manufacturer 304. Each of these organizations may independently specify their intents in terms of what data they wish to receive regarding the item, as well as in terms of what data they are willing to share. Assume, for instance, that manufacturer 304 wishes to know the state of its item in terms of where it is, when it arrived at its current location, when it leaves, the level of inventory in its final destination, etc. Through the use of identity federation and visibility service 302, the other organizations 306-312 may provide updated information to identity federation and visibility service 302 regarding the item, automatically, allowing manufacturer 304 to access this information via identity federation and visibility service 302.

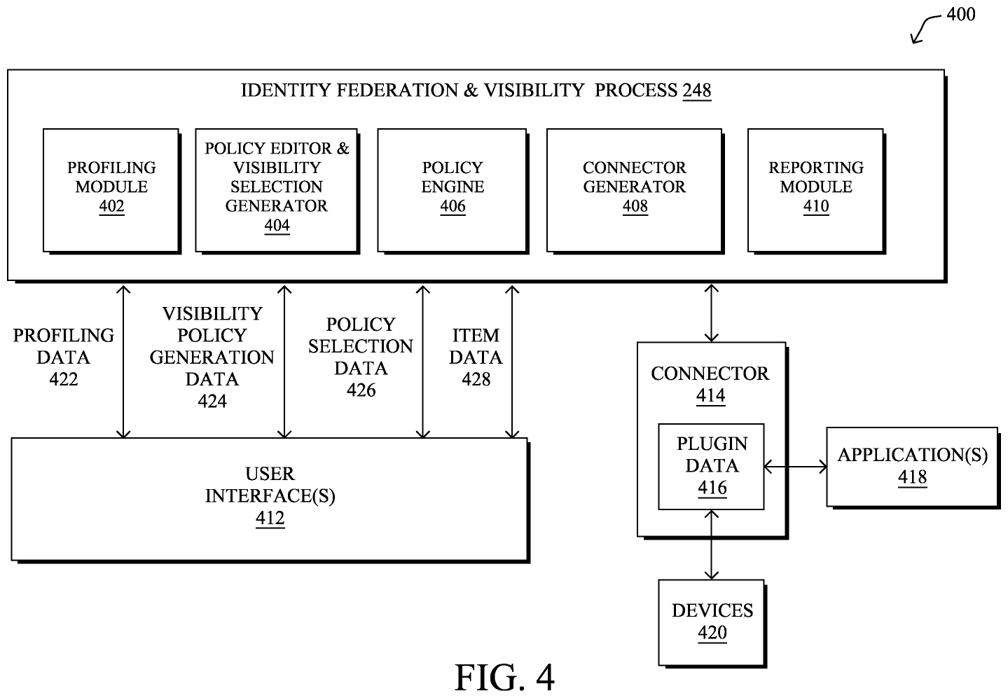

FIG. 4 illustrates an example architecture 400 for an identity federation and visibility service, such as identity federation and visibility service 302 in FIG. 3. At the core of architecture 400 is identity federation and visibility process 248 which may comprise any or all of the following components: a profiling module 402, a policy editor & visibility selection generator 404, a policy engine 406, a connector generator 408, and/or a reporting module 410. As would be appreciated, the functionalities of these components may be combined or omitted, as desired. In addition, these components may be implemented on a singular device or in a distributed manner, in which case the combination of executing devices can be viewed as their own singular device for purposes of executing identity federation and visibility process 248.

During execution, identity federation and visibility process 248 may communicate with any number of user interface(s) 412 operated by any number of people across any number of organizations. For instance, user interface(s) 412 may comprise desktop computers, laptop computers, smart phones, tablet devices, wearable electronic devices, or the like.

According to various embodiments, a domain expert for an organization may use user interface(s) 412 to specify profiling data 422 to identity federation and visibility process 248. In turn, profiling module 402 may use profiling data 422 to define a set of selectable visibility policies for the organization or a domain of the organization. In other words, profiling module 402 may generate and expose a set of pre-defined visibility offerings and intents that could be applied and/or modified later on by a particular organization. For instance, profiling data 422 may define different organization types, such as, but not limited to, manufacturers, warehouse operators, transporters, etc., in the case of a supply chain. In other embodiments, identity federation and visibility process 248 may be used to set up a federation in other use cases, as well, such as healthcare, insurance, or the like. As would be appreciated, the domain expert(s) may be unaffiliated with the specific organization participating in an identity federation and may simply provide a base set of defaults for process 248 for the usage domain (e.g., supply chain, healthcare, etc.).

The domain expert(s) may also provide visibility policy generation data 424 that allows policy editor & visibility selection generator 404 to automatically generate predefined policy templates. In general, visibility policy generation data 424 indicates the types of data that an organization with a particular profile may be able to share and/or the types of data that it may wish to be able to access. For instance, a policy template for a particular type of organization, as indicated by its profile, may specify a predefined set of preferences for its visibility intent and visibility offerings. In addition, the choices available for selection in the template may also depend on the organization type of the participant and/or those with whom the organization is to interact as part of the supply chain. For instance, a Manufacturer profile may be associated to a Manufacturer policy template, while a Warehouse might be associated to a Warehouse policy template. Based on these two policy templates and considering the (Manufacturer, Warehouse) pair, policy editor & visibility selection generator 404 may auto-render a predefined set of choices that each member of the pair can select to express its visibility intent and offerings. Likewise, policy editor & visibility selection generator 404 may auto-render a predefined set of choices for a (Transporter, Warehouse) pair or a (Manufacturer, Transporter) pair. The list of auto-rendered policies may vary depending on the members profiles. For example, the visibility choices auto-rendered by policy editor & visibility selection generator 404 for (Manufacturer_1, Warehouse_1) and (Manufacturer_2, Warehouse_2) would be the same, while the one for (Transporter_1, Warehouse_1) might differ.

Thus, as a result of the processing by profiling module 402 and policy editor & selection generator 404, identity federation and visibility process 248 now has a set of default visibility policies that indicate the set of ‘intents’ of the organization or domain in terms of which data that it is able to share (e.g., its ‘visibility offerings’), as well as any information that it can access from another organization (e.g., its ‘visibility intent’).

Once the above initializations have occurred, specific organizations and their users may be onboarded by process 248. Such a registration may, for instance, associate a particular organization with a profile type and, accordingly, a set of default policy templates for them. For instance, a particular user at Warehouse A may provide details to process 248 regarding their organization (e.g., location information, contact information, etc.). In addition, this information may also indicate the specifics of the capabilities of the systems of the organization, such as its software systems, identification technologies in use, and/or any other information that may be captured regarding the participating organization. For instance, this information may indicate, for a particular organization or domain, which identification technologies are in use by that organization, such as RFID tags, barcodes, Wi-Fi, cellular, BLE tags, UWB, and the like.

In various embodiments, a user associated with a particular organization registered with process 248 may specify policy selection data 426, which is used by connector generator 408 to construct and deploy the appropriate connector(s) 414, to facilitate the corresponding sharing of data across organizations. Typically, policy selection data 426 comprises a selection of the visibility intent and/or visibility offering of that user. For instance, policy selection data 426 may take the form of checkbox input that allows a user to select from among the template policy options generated previously by policy editor & visibility selection generator 404 and based on the specific profiles of the organizations involved.

Regarding visibility selection, the identity federation and visibility service may provide display data to a user interface associated with a 3^{rd} party warehouse (e.g., Warehouse W), thereby allowing a user of that organization to specify policy selection data 426 for a Manufacturer M (e.g., manufacturer 304). For instance, display data may take the form of a user interface (e.g., graphical user interface-based) checklist via which the user is able to specify the policy target(s), send policy data regarding what types of information should be sent, as well as the corresponding receive policy data. Similarly, other display data may be sent to a user interface associated with Manufacturer M, also a participant in the identity federation, that allows that organization to specify its own policy target(s), send policy data, and receive policy data, with respect to Warehouse W.

As would be appreciated, the options available to a user may vary depending on the organization type, the peer's organization type, identification technology, etc., and selectable pairs may be auto-rendered based on profile pairs (e.g., a manufacturer-warehouse pair, a warehouse-carrier pair, etc.). For instance, a warehouse operator may specify any or all of the following as part of a send policy: notify arrival, notify departure, in stock query, quantity in stock query and specify any or all of the following as part of a receive policy: estimated time of departure (ETD) updates, asset description, or asset state. In contrast, a manufacturer may be able to specify any or all of the following as part of a send policy: ETD updates, asset description, or asset state. In addition, the manufacturer may specify any or all of the following as part of a receive policy: notify arrival, notify departure, in stock query, quantity in stock query. Another example selection may indicate the location of a particular item (e.g., in terms of coordinates), which may be of interest with respect to a transporter.

According to various embodiments, policy engine 406 may match visibility intents and visibility offerings specified via policy selection data 426 across any number of organizations or domains. For instance, one organization may wish to receive a notification when another organization receives any of its shipped goods. If the second organization specifies a visibility offering that matches the visibility intent of the first organization, policy engine 406 may implement the corresponding data sharing policy between the two organizations. In other words, the role of policy engine 406 may be to: 1.) hook, map, and manage the send and receive policies produced by policy editor & visibility selection generator 404, 2.) perform matching among those send and receive policies selected via policy selection data 426, and/or 3.) distribute the policies to the identity federation core and to the applicable connectors, such as connector 414, as detailed below.

As would be appreciated, the set of available options for an organization, as well as its selected visibility offerings and intents, can change over time. Indeed, even though a default set of selectable options may be configured for an organization, these options can be modified over time, as needed, in some embodiments. For instance, say an organization outfits its warehouse with BLE scanners. In such a case, a person associated with that organization may specify this new offering as an option to identity federation and visibility process 248. In turn, the new options will be auto-rendered and made available to the users of the federation. Similarly, a user may adjust their policy selection data 426 over time, such as when additional information is desired, certain information is no longer of interest, etc. Indeed, even though process 248 may present users with default options to set visibility policies, these options could be modified over time. For instance, in some embodiments, this could be instrumented either via a new configuration by an authorized user or programmatically (e.g., through 424), including the introduction of new visibility policies and data models.

Identity federation and visibility process 248 may also maintain any number of identity federations across open, semi-private, or private consortia of the various organizations. In addition, members may be part of multiple identity federations maintained by identity federation and visibility process 248, simultaneously.

In some embodiments, an identity federation may be implemented as an unmanaged service, through the execution of identity federation and visibility process 248, with no requirement for an identity federation provider to operate the federation. This allows the federation to begin functioning as soon as a first organization establishes it and invites a second organization to participate in the federation and start exchanging data.

In the case in which a user opts to start a new identity federation, the user may specify this to process 248, such as the name of the new identity federation, invitees to the federation, and the like. In one embodiment, identity federation and visibility process 248 may also suggest invitees to the user via user interface 412 and/or allow the user to pick invitees from a predefined list. This may be based, for instance, on the prior selections of the user and/or organization for other identity federations, the most common invitees (e.g., particular transporters, etc.), a template defined by the user, or the like.

As would be appreciated, not all of the invitees specified by a user may be registered with identity federation and visibility process 248. In such cases, the user setting up a new federation may also specify information such as any or all of the following:
1. The name of the invitee (e.g., ‘Warehouse W’).
2. An email address or other contact information to which identity federation and visibility process 248 may send an invitation for the identity federation.
3. A member role that indicates the allowed activities for the invitee within the federation (e.g., “member,” “co-owner,” “member with the right to invite others,” etc.).
4. Membership duration information (e.g., one day, one week, permanent, etc.).
5. Other information regarding the invitee (e.g., the location of the invitee, notes, etc.).

Note that, in some instances, the creator of an identity federation via identity federation and visibility process 248 may also delegate the ability to invite others to one or more invitees. This is an important capability, as many logistics and transportation companies rely on several layers of subcontracting in order to deliver an outcome. By extending invitations to subcontractors so that they can participate in the identity federation and exchange information about an item, visibility of the item can be greatly improved. Once the process is complete, identity federation and visibility process 248 may send invitations to the selected invitees (e.g., by sending links to identity federation and visibility process 248 by email, text message, etc.).

In general, an invitation to join an identity federation may identify the federation to the invitee and may include security token information that identifies the invitee to identity federation and visibility process 248. Once registered with identity federation and visibility process 248, or logged into an existing account, the invitee may enroll with the created identity federation. During this step, each party may select whether its profile should be public or not (e.g., whether the company/entity name should be publicly available and listed). An organization may also maintain different accounts and/or user roles, such as when the organization participates in different identity federations. For instance, a member may create internal tenant accounts, such as a ‘viewer’ account, an ‘admin’ account, etc.

According to various embodiments, connector generator 408 of identity federation and visibility process 248 may be configured to generate any number of ‘connectors’ for the participants in a federation, based on matches between their visibility offerings and visibility intents. For instance, connector generator 408 may generate connector 414 that encompasses the software necessary to interface with the item identification technologies used by a particular organization/participant in an identity federation.

As would be appreciated, item information may depend heavily on the internal systems of the source organization. For instance, different organizations may maintain item information in various enterprise-level applications or systems, such as an Enterprise Resource Planning (ERP) system, a Warehouse Management System (WMS), a Warehouse Execution System (WES), a Transport Management System (TMS), or the like. To this end, connector generator 408 may be configured to select plugin data 416 for inclusion in a connector (e.g., connector 414) that facilitates the sharing of information from that resource. For instance, assume that an organization uses one or more application(s) 418 to maintain item information, such as a TMS. In such a case, plugin data 416 may include the information needed to interface with the TMS of the organization (e.g., credential information, etc.), to obtain or update information about an item in transport by the organization. Similarly, a connector 414 may be configured to share data from particular device(s) 420, such as an RFID reader, etc., via the federation.

Typically, the communications enabled by plugin data 416 may be limited to accessing only the information needed to support the visibility intents and visibility offerings associated with the various participants, as determined and enforced by policy engine 406. For example, assume that Warehouse W1 receives a pallet of RFID-tagged items from Manufacturer M. As soon as an RFID reader of Warehouse W1 scan the items, the corresponding information may be captured into the application(s) 418 of Warehouse W1 and captured by way of plugin data 416, which may comprise one or more plugins for those application(s) 418. In reading the information encoded on the RFID tag, the system is able to determine the identity provider as being Manufacturer M. This then determines that the information should be ‘routed’ according to the policy associated with Manufacturer M. Note that this data flow may occur because Manufacturer M specified a visibility intent of “notify arrival” that matched a visibility offering selected by Warehouse W1.

In further embodiments, connector 414 may include plugin data 416 configured to interface with the device(s) 420 of the organization, directly. For example, connector 414 may receive data in parallel from any number of deployed RFID scanners in addition to, or in lieu of, interfacing with a WMS or other application 418 of that organization. For instance, connector 414 may obtain scan information directly from a scanner, but may obtain inventory count information from a WMS or other application 418.

According to various embodiments, connector generator 408 may construct a connector 414 based on the profile of the organization, its identification technologies, and/or its corresponding plugins. In general, connector 414 functions as an entity that allows an organization to connect to identity federation and visibility process 248 and exchange data flows. For security reasons, connector 414 may also include a certificate signed by connector generator 408, to certify its identity to the identity federation and visibility process 248. Likewise, the identity federation and visibility process 248 may also handle a certificate to certify its identity to the organization's connector 414.

Assume, for instance, that a participant in an identity federation has specified the following: Profile=“Warehouse”; Technologies=“(RFID, Barcodes)”; Plugin=“Oracle's WMS version X”; CERT=“W_autosigned”. In this example, connector 414 may take the form of a software element (e.g., an image), which, once instantiated, embeds the processes providing the following functionality:
A list of policies that the participant can select to define its visibility intent, based on its profile, which may be modifiable on a per-participant basis.
A list of policies that the participant can select to define its visibility offering, based on its profile, which may also be modifiable on a per-participant basis.
The ability to parse and forward Electronic Product Codes (EPCs) from is application(s) 418 and/or device 420, which is the standardized identity format used both by RFID tags and Barcodes.
Plugin data 416 to parse and forward a set of messages to/from Oracle's WMS (e.g., an application 418).
Code to create secure communications with identity federation and visibility process 248 that are authenticated using the certificate information provided by connector generator 408.

In some embodiments, a new connector 414 may be instantiated for each identity federation in which an organization participates. In another embodiment, a single connector 414 may include the ability to slice and isolate item data from different identity federations, as in the case in which the organization is participating in multiple identity federations. In further embodiments, connector 414 may also be configured to store and cache policies (e.g., by implementing a localized form of policy engine 406).

Once connector generator 408 has generated a connector 414, identity federation and visibility process 248 may deploy it to its target organization either on a push basis or on a pull basis (e.g., in response to the organization requesting a download of connector 414). As noted, the specific configuration of connector 414 may depend on the identification technologies and/or plugins specified by the target organization. For instance, if RFID and barcodes were chosen, connector 414 may be configured as yet another data consumer in the existing data capture workflows of the organization, as well as interface with internal application(s) 418. In a further enhancement, connector 414 may also interface directly with the endpoint devices and/or networking equipment responsible for capturing and reporting the item data. For instance, connector 414 may be configured to interface with BLE beacons, UWB anchors, Layer 2 switches, wireless access points, wireless access point controllers, or the like. To support this, connector generator 408 may include the corresponding plugin data 416 into connector 414, such as the plugin data needed to interface with application programming interfaces (APIs) of a is network switch, barcode reader, etc.

Once connector 414 has been deployed, it may automatically and securely connect to identity federation and visibility process 248 (e.g., the service) and/or directly with other connectors of other participating organizations in the federation. This may be achieved by establishing a mutual transport layer security (mTLS) tunnel, for instance. Thus, as shown previously in FIG. 3, identity federation and visibility service 302 may communicate with organizations 304-312 via secure tunnels that are established with corresponding connectors 414 deployed to those organizations. In turn, the connectors may report the required item data to service 302, as needed.

Policy engine 406 is also responsible for enforcing the visibility policies generated by policy editor & visibility selection generator 404. As would be appreciated, the visibility policies between organizations may differ. Indeed, the policies for exchanging data between a transporter and a warehouse operator may differ from the policies for exchanging data between a manufacturer and a warehouse operator. Thus, a warehouse operator may share certain information with a carrier that the shipper (e.g., the manufacturer) may not be allowed to view.

Policy enforcement by policy engine 406 can be achieved by placing restrictions on reporting module 410, which is responsible for reporting any item data collected by a connector 414 to any of the other participants of the federation that match that data. In turn, reporting module 410 may provide that collected item data as item data 428 to the authorized organizations via user interface(s) 412. Note that the functionalities of reporting module 410 may also be implemented as part of connector 414, thereby allowing connector 414 to report item data 428 to one or more other connectors, directly, for presentation to a user interface 412. In various embodiments, item data 428 may be sent via the corresponding connector(s) 414 deployed to the destination organization(s) authorized to receive the item data. This allows, in some instances, item data 428 to be fed into the system(s) of that organization via the plugin data of the connector. For instance, in some cases, item data 428 may automatically populate the ERP system of the is organization receiving item data 428.

By way of illustration of the operation of the full system, consider again the case shown in FIG. 3. Assume that manufacturer 304 ships an item with a passive RFID tag to warehouse operator 310. An RFID reader in the warehouse may read the data in the RFID tag, providing local visibility to the systems of warehouse operator 310 (e.g., a WMS application, etc.). The item data read by the RFID interrogator thus reaches the connector deployed to warehouse operator 310, allowing the connector to either find a matching entry or filter the data. Various embodiments could be used to enable such functionality at the connector level. For example, connectors might cache the ID of the owners (or identity providers) along with the corresponding visibility policy. Another option could be to push policy and updates to the connectors. The connectors might also be stateless and might not be endowed with any caching mechanism, in which case, the messages will always hit the federation.

In more complex examples, visibility policies may allow for different levels of aggregation, such as by aggregating groups of item identifiers. For instance, a ‘notify arrival’ policy may be applied to an entire pallet of items, rather than for each of the individual items on the pallet.

In some embodiments, the identity federation may be used for exchanging both identity-related data, as well as context and state-related data, subject to the visibility policies described above. In other words, identity federation and visibility service 302 may serve as both the control plane and data plane, to enable the desired levels of visibility among parties in the supply chain. In other embodiments, the identity federation may only carry control plane data and may provide trusted pointers (e.g., endpoint addresses), so that the parties can exchange context and state-related data directly among themselves. In a further enhancement, the identity federation may support a hybrid model, providing both control and data plane functions for certain types of identities, profile members or visibility functions, while providing control and data plane separation for others.

In further enhancements, the identity federation may support any or all of the is following:
more flexible profiles and templates, such as customizable templates;
programmable/extensible policies;
programmable/extensible plugins;
more flexible certificate and handling or even a full-fledged public key infrastructure (PKI);
additional decoupling between the identifying/routing functions and the exchange of context and state-related data.

According to various embodiments, the federation techniques herein can also be extended to exchange information regarding connected assets and/or the workforce of the organizations. For instance, assume that warehouse operator 310 has deployed a number of AMRs or automated forklifts in its warehouse. In such cases, the connector deployed to warehouse operator 310 may also interface with their corresponding systems, to provide the manufacturer of those devices (and any other authorized participant of the federation) information regarding these devices. Similarly, personnel information could also be captured and sent, through the use of the appropriate connector and plugins. For instance, warehouse operator 310 may send to transporter 308 information regarding the precise location of the item, identification of the robot or person transporting the item within the warehouse, and an expected time that the item will be ready for pickup by transporter 308.

Warehouse operators are increasingly leasing high-value equipment, such as AMRs and the like. Since such systems require data network communication in order to operate. AMRs or unmanned forklifts represent third-party devices that require trusted access to the warehouse network. Thus, identity federation and visibility service 302 may be used to dynamically identify these assets and enable trustworthy communications between these assets and the management systems of their corresponding service providers, which may be integrated into the federation as additional participants.

For instance, warehouse operator 310 may exchange data gathered through a Wi-Fi technology connector with remote Forklift or Robotics Management systems running in a remote location, such as a cloud-hosted compute facility. However, it may exchange data gathered only through the RFID connector with other parties upstream in the supply chain, including the manufacturer/seller of the items tagged with RFID.

When various processes within the supply chains are performed optimally, the supply chains can be understood as extremely efficient. However, exceptions, in other words unexpected events that occur either directly within the supply chain or impact the environment within which the supply chain(s) operates, can significantly impact the performance of supply chains. The interconnected nature of the supply chain network means that adapting to exceptions is an intrinsic part of everyday operations.

A supply chain may be subject to a variety of exceptions (e.g., quality issues, delays/closures, temperature violations affecting items either in stock or in transit, etc.) and across a variety of siloed systems. For instance, assume that there are multiple entities or organizations involved in the supply chain (e.g., a supplier, an owner of the shipped goods, and a set of partners). Each of these may have their own corresponding systems, such as the supplier's enterprise system, the partners' management systems, etc. Now, assume that the supplier detects a quality issue in one of its components. When this happens, the supplier notifies the issue to the owner. This is usually referred to as a Supplier Quality Alert (SQA), and it would typically affect goods that were already shipped and are now under the custody of the owner and its partners. As a result, the owner needs to contact its partners to identify the number of parts affected and their corresponding location.

Today, when such issues occur, manual interactions take place between the supply chain entities in order to determine the level of impact. Emails will be sent, phone calls will be made so that information can be gather, remedial actions planned and then executed—but time is a critical factor. The time taken for each of the partners to respond to request for information can be lengthy, not just for obtaining and reporting back but is even for acknowledging the initial request since these interactions typically rely on human-to-human engagement.

Conventionally, then, exception handling (e.g., resolution of the unexpected events) is performed by teams of supply chain professionals, with each incident being assessed and addressed on a manual, case-by-case basis. This is often due to the lack of automation and data collection tools along the supply chain. Particularly, given the wide variety of exceptions that can and do occur, finding and implementing timely resolutions for each becomes increasingly complex. For example, exceptions can range from assets being damaged (due to environmental conditions), lost in transit, impounded at customs checks because of incomplete documentation, etc. Severe weather can also result in significant delays in ocean freight shipments (that are part of a supply chain). In addition, there may be various “knock-on” effects that may impact production options. For example, increases in demand for a particular product can result in producer, which are part of a supply chain, unexpectedly requesting additional raw materials or components from their suppliers with a short time window for both confirmation of availability and delivery. The complexity of supply chain networks and the large number of entities contributing to both decision-making and execution exacerbate the challenge. It is common for there to be many different forms of information gathering and reporting systems in use, with minimal sharing between multiple siloed systems.

### Deterministic Exception Handling for Item Identity Federation and Visibility as a Service

The features provided by the example identity federation and visibility service (for supply chain partners), according to various embodiments described above, enables previously siloed systems of a supply chain to share information with one another. The techniques herein further introduce an exception handling process 249 to provide for deterministic exception handling for item identity federation and visibility as a service.

By analyzing the federation and monitoring of an entire supply chain among conventionally separated organizations, the techniques herein enable the ability to quickly assess and address exceptions that may arise in supply chains, with limited is intervention. The delivery of physical assets or goods across a supply chain can be understood or modeled as a finite state machine. When the processes within the supply chain are performed optimally, the supply chain can be extremely efficient. However, exceptions, as described above, can significantly impact execution of the entire or part of the supply chain if they are not addressed in a timely fashion (i.e., unexpected events that occur either directly within the supply chain, environmental conditions like temperature, humidity, etc. within which the supply chain operates, etc.). The techniques herein enable both exception detection within a supply chain as well as exception handling (e.g., resolution and/or notification) by leveraging identity federation and visibility service(s) within a supply chain. That is, by automatically detecting exceptions of various types (as described above), the techniques herein are able to automatically implement corresponding corrective measures. For example, by monitoring connectors at suppliers and or shippers, events involving damaged goods or delayed goods can be either reported or detected, and remedies and/or notifications for each of these instances may be deployed.

Illustratively, the techniques described herein may be performed by hardware, software, and/or firmware, such as in accordance with the exception handling process 249 (in combination with identity federation and visibility process 248), which may include computer executable instructions executed by the processor 220 (or independent processor of interfaces 210) to perform functions relating to the techniques described herein.

Specifically, according to various embodiments, a device obtains, from a service connector of a first organization, event data for an event regarding shipment of one or more physical assets between organizations. The device identifies, based on the event data, a response policy associated with the event. The device identifies, based on the response policy, a second organization that is affected by the event. The device sends a notification regarding the event to a service connector of the second organization to initiate a corrective action for the event.

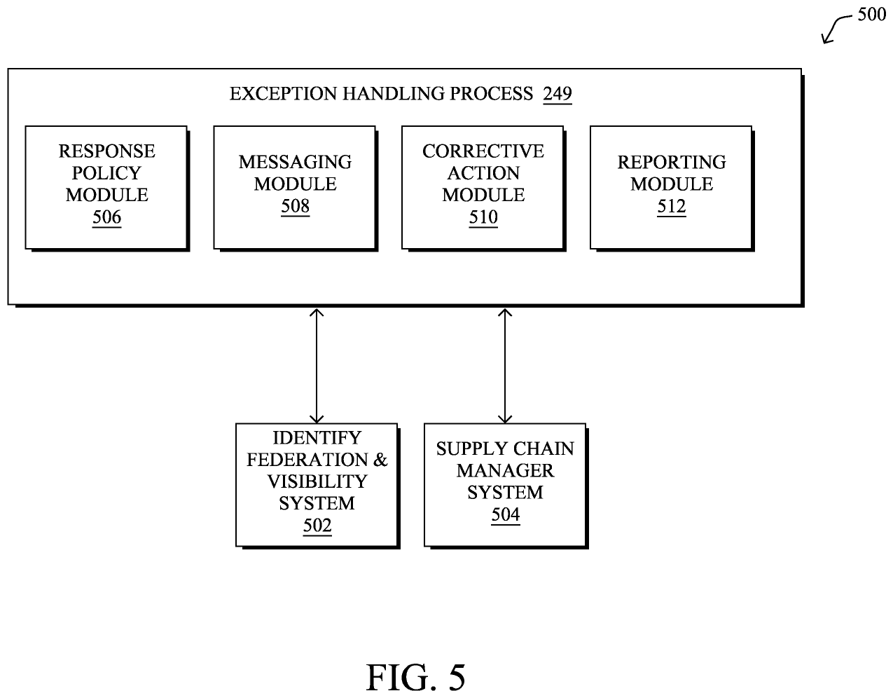

Turning now to FIG. 5, an example exception handling system for an identity is federation and visibility service is shown. In particular, exception handling system 500 comprises exception handling process 249 that may be in communication with identity federation and visibility system/service 502, where identity federation and visibility system/service 502 includes one or more supply chains that have identity federation and visibility process 248 implemented according to techniques described herein above. Furthermore, exception handling process 249 may be in communication with a supply chain manager system 504, which enables one or more supply managers to monitor the one or more supply chains that has identity federation and visibility process 248 implemented. Exception handling process 249 may comprise response policy module 506, messaging module 508, corrective action module 510, and reporting module 512.

Response policy module 506 may be configured to define the response policies from supply managers operating supply chain manager system 504, where respective response policies not only define various parameters that may be met to identify the type of exception within identity federation and visibility system/service 502 but also define the orchestration required to instrument corrective actions. Such orchestration may define not only a specific sequence of actions and messages required to handle a given exception in a prescriptive manner, but also the time boundaries to respond and implement corrective actions in a deterministic manner for each partner involved in the workflow. More specifically, the response policy module 506 may be configured to define and manage a playbook with different orchestration processes (e.g., response policies), which may stipulate:
a) the categories and types of exceptions handled by process 249,
b) the partners involved in each exception handling process,
c) specific message types that need to be exchanged between the partners involved to handle the exception,
d) the orchestration of messages and sequence of actions required to instrument the remediation,
e) the time boundaries associated with each step of the orchestration to ensure is deterministic remediation.

For example, an exception may be invoked when goods are delayed by predetermined number of days, environmental conditions being met contemporaneously with goods being located at a certain situation, etc. That is, when a shipment does not arrive at a destination at a certain time, an exception may be identified, and a specific exception type/event may be invoked. Alternatively, when temperature, humidity, etc. of an environment around a shipment (e.g., a container) are not met, an exception may also be invoked. Alternatively, an exception may be invoked when an order size that is beyond “normal” bounds, or a quality issue is detected. While some of these various parameters may be monitored and notified by leveraging the observability provided by identity federation and visibility process 248 within identity federation and visibility system/service 502, others may be notified by a supply chain operator. Indeed, an exception may be invoked either automatically (e.g., issued by an application or by the identity federation and visibility process 248) or manually (e.g., generated by a supply chain manager).

Messaging module 508 of exception handling process 249 may be configured to receive and send messages to various connectors of identity federation and visibility system/service 502 as well as operators (e.g., using collaboration or messaging tools) to orchestrate and implement corrective actions to parts of a supply chain that various organizations are in charge of. For example, one organization may be responsible for preparing and production of a physical asset or good, another organization may be responsible for customs and freight, and a particular organization may be responsible for assembly of a product (using the physical asset or good). Module 508 may be used to receive and send various messages to orchestrate and coordinate responses to exceptions that are detected by exception handling process 249 according to the supply chain manager's response policies defined in 506. Further messaging module 508 may be configured to correspond with connectors of organizations with identity federation and is visibility system/service 502 to ascertain specific goods that may be delayed or missing (e.g., using their identifiers) as well as their location(s). For example, exceptions can be detected, then confirmed by monitoring organizations before and after where a shipment should be.

Corrective action module 510 may be configured to, in response to detection of an exception, orchestrate and control the various messages and corrective actions that are defined within the response policy module 506 (as defined and set up by supply chain managers). For example, corrective action module 510 may “translate” fixes within response policies into commands, language, etc. that are received at connectors of organizations, where the connectors are configured to communicate to and instruct various devices, as describe above with respect to identity federation and visibility system/service 502. For example, corrective action module 510 may orchestrate the sending of a notification (or instruction) to a connector to initiate a replacement shipment of goods or assets in response to detection of a delay by another organization. Indeed, module 510 may represent the orchestration engine of exception handling process 249.

Notification module 512 may be configured to send notification messages to various organizations that are located external to the identity federation and visibility system/service 502, for example, directly to supply chain managers (e.g., using a messaging or collaboration tool). Supply managers may monitor exception detection as well as corrective actions that are implemented by exception handling process 249, individually or in the aggregate. For example, supply managers may confirm that a physical asset is delayed or that a certain corrective measure should be taken by having visibility across an entire supply chain, where previously it could not.

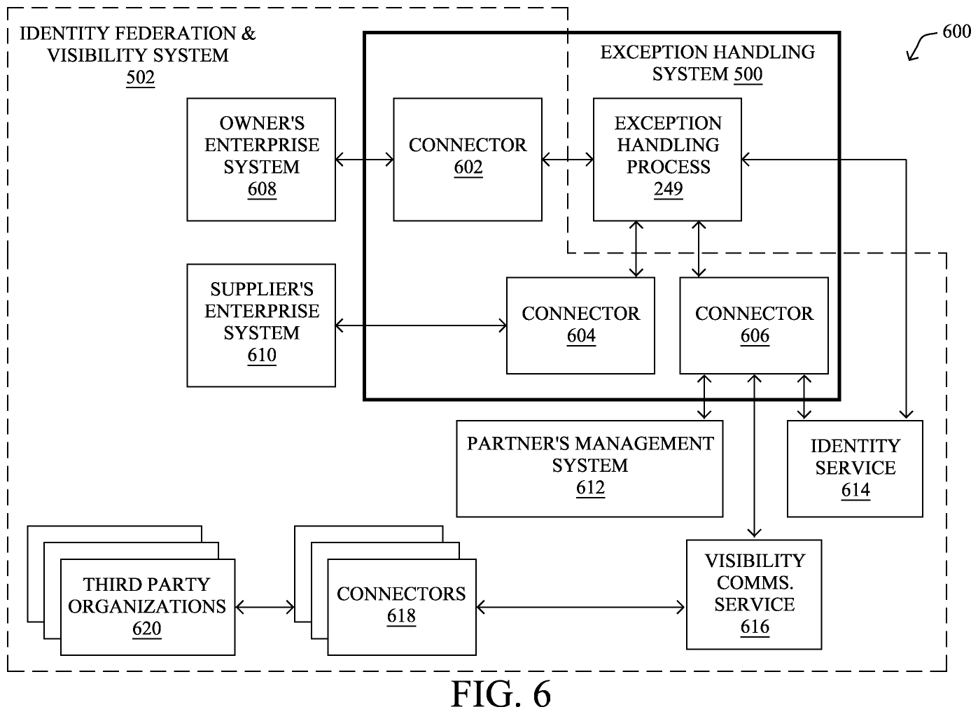

Turning now to FIG. 6, an example architecture 600 for an exception handling system 500 for an identity federation and visibility system/service 502 is shown. As shown, exception handling process 249 may be in communication with connector 602, connector 604, and connector 606 that are each in communication with different organizations and their systems of identity federation and visibility system/service 502. Notably connector 602 may be monitored and installed by an owner's enterprise system 608, while connector 604 may be monitored and installed by a supplier's enterprise system 610. Connector 606 may be in communication with a partner's management system 612 as well as an identify service 614 and visibility communications service 616. Visibility communications service 616 may be connected to a plurality of connectors 618 that are monitored and installed by a plurality of third party organizations 620. Each of the organizations shown in FIG. 6 may comprise one or more manufacturers, producers, shippers, freight and carriers, terminal ports, warehouses, distribution centers, 3PL, 4PL and 5PL, last mile delivery, retail stores, hospitals, insurance companies, etc.

Each of the connectors described within FIG. 6 may be configured to implement the functions described herein above with respect to FIGS. 3-4. Notably, the connectors may be configured to provide event data regarding statuses of various physical assets that may be part of a supply chain as well as environmental conditions and supply/demand conditions of the physical assets. For example, the connectors may be able to monitor and poll the status of a package that goes from a supplier to a shipper. In addition, the connectors may be configured, via sensors or other devices, to monitor temperature, humidity, etc. of environments (e.g., warehouses, freight containers, etc.) which the physical assets may be placed. In addition, the connectors may, within some organizations, may be able to monitor sudden increases or decreases in demand (e.g., outside a predefined range) for various physical assets. Further, as described in more detail herein, the connectors are in communication with exception handling process 249 which receives both the gathered event data and instructs the various connectors to cause corrective actions (or measures) to be taken in response to detection of various exceptions (defined within response policies).

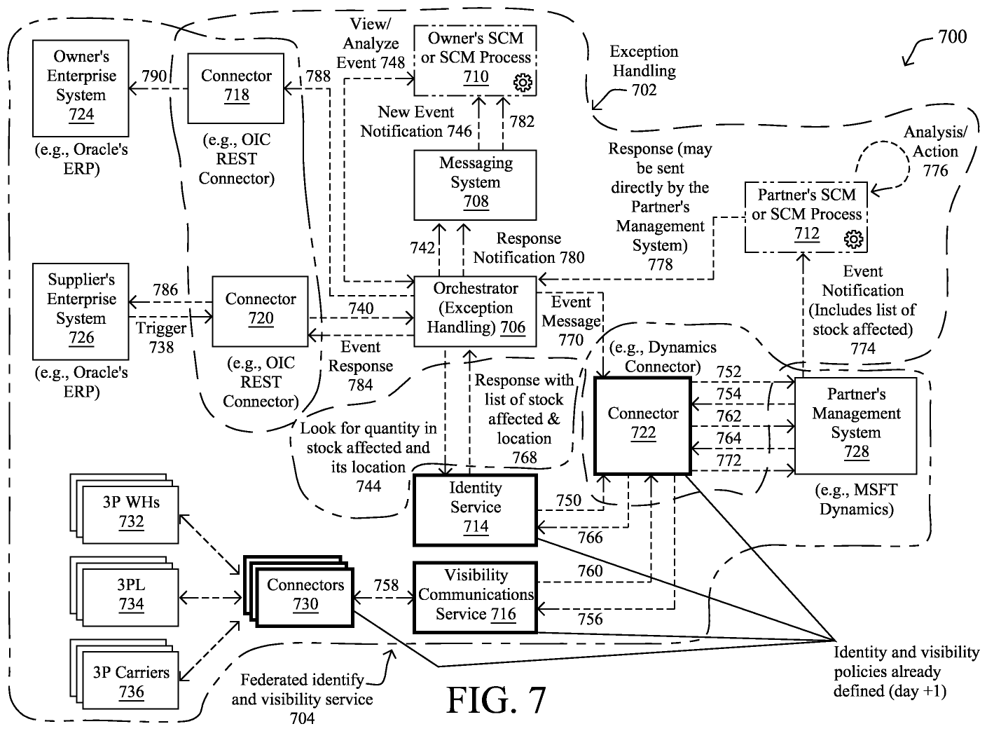

FIG. 7 illustrates an example flow diagram 700 for an exception handling service for an identity federation and visibility service; in particular, how a Supplier Quality Alert (SQA) or an exception may be handled within a supply chain that implements exception handling system 702 and identity federation and visibility system 704. Preliminarily, one of the most critical parts leading to variable time to solve exceptions is determining a) “who” has the parts or assets affected (i.e., which organization) and b) is “where” are those parts or assets located (i.e., where within the organization).

Exception handling system 702 may comprise an orchestrator 706 (e.g., exception handling process 249), a messaging system 708, an owner's supply chain manager (SCM) or SCM process 710, and a partner's SCM or SCM process 712. Identity federation and visibility system 704 may comprise an identity service 714 and a visibility communications service 716, which together comprise an identity federation and visibility process 248 and connector 718, connector 720, connector 722 that are respectively connected to an owner's enterprise management system 724, a supplier's enterprise system 726, and a partner's management system 728. Connectors 718, 720 and 722 may also be considered part of the exception handling system 702, as they may be common elements present in both systems 702 and 704. In communication with visibility communications service 716 may be a plurality of connectors 730 that are individually in communication with third-party organizations, including third-party warehouse system 732, third-party logistics systems 734, and third-party carrier systems 736 (as described with greater detail herein). The process to automatically handle such an event may operate as follows:

At step 738, an SQA event or other exception may be automatically triggered by the supplier's enterprise system 726. The alert may specify the detected quality issue and the identifiers of the goods affected (e.g., corresponding part numbers might be sent as part of trigger message at step 738), for example, by a response policy set up by the supplier or an SCM. The supplier's enterprise system 726 may communicate the exception through a connector 720 associated to the supplier's enterprise system 726. At 740, a connector 720 at the supplier's enterprise system 726 may process and forward data indicative of the exception event to an orchestrator 706 (e.g., exception handling process 249).

As described herein above, orchestrator 706 may be connected to the various organizations and their systems through their respective connectors, so upon receiving the event, the orchestrator 706 may identify the type of exception and automatically initiate is the corresponding exception handling method. To make this possible, the exception handling process 249 (on the orchestrator 706) may have already defined a policy detailing the steps and time boundaries for executing the automated orchestration process. Such policy might be configured by an SCM affiliated to the owner of SCM process 710 or owner's enterprise management system 724 (e.g., in day −1). More specifically, the owner's SCM might manage a playbook with different orchestration processes (e.g., response policies), which might be invoked and executed depending on the event received by the orchestrator 706 (i.e., depending on the type of exception event received by this latter). In the example in FIG. 7, the orchestrator 706 may concurrently send two messages, a notification message at step 742 and message at step 744, respectively, to messaging system 708 and identity service 714. Notification message of step 742 and message of step 744 may be processed by respective receiving organizations in parallel.

Orchestrator 706 may rely on its messaging module to send notification message from step 742, which sends the event notification to notify either a supply chain manager (SCM) or a SCM process 710 (e.g., using email, SMS, or preferably, a collaboration tool, such as Cisco Webex, etc.). Once the SCM process 710 receives the event notification 746, the SCM process 710 may, at step 748, either connect to the exception handling process 249 to visualize and analyze the event and its progress via a graphical user interface or message cascade as understood in the art, or may receive and process updates automatically (e.g., through messaging system 708). This may be done through back and forth communication with exception handling process 249 at orchestrator 706, in some embodiments.

For the message from step 744, exception handling process 249 may proceed with communicating with identity service 714 to determine a location of the one or more physical goods that are affected by the detected exception. For instance, identity service 714 may send a plurality of messages to a specific partner with the aim of obtaining: a) the number of parts affected under its custody; and b) their corresponding location. To this end, orchestrator 706 might automatically communicate with identity service 714 with message of step 744, providing as inputs the ID of the partner as well as the IDs of is the parts affected. Based on the partner ID, the identity service 714 may identify the partner's connector and forward a query at step 750 to a corresponding partner (e.g., to connector 722 of partner's management system 728). The query might be processed by the connector 722 and forwarded to a partner's management system 728, for example, to an enterprise resource planning (ERP) system at step 752. In turn, the partner might rely on services provided by third-party organizations, such as third-party logistics system (3PL) 732, third-party logistics systems 734, third-party carrier system 736, etc. Some of the parts affected might be under the custody of those partners. Hence, the automated message flow from step 754 to step 762 and allows the partner's management system 728 to gather such information from its own partners by leveraging the connectors and a visibility communications service 716. This might be supported by visibility policy defined in day ‘−1,’ (e.g., prior to execution of the displayed flow), which may have been pushed across the identity federation and visibility process 248 (including corresponding connectors) in a distributed manner. The partner's management system 728 may now aggregate the information received and respond to the query issued by the orchestrator 706 in steps 764 to 768.

The event flow from step 744 to step 768 may be conducted across several partners concurrently with messages from the connectors 730 with third-party organizations, including third-party warehouse system 732, third-party logistics systems 734, and third-party carrier systems 736. For example, exception handling process 249 may send messages to several of the owner's partners, including third-party warehouse system 732, third-party logistics systems 734, third-party carrier systems 736 simultaneously. As a result, the owner, via the partner's management system 728, may receive several responses from its partners through the exception handling process 249, each of which may indicate the number of parts they have, their IDs, and their location.

Depending on the results received from the different partners, orchestrator 706 (e.g., exception handling process 249) may selectively initiate corrective actions with specific partners (e.g., involving only those that do have at least one part affected). For is instance, the exception handling process 249 may send messages (e.g., control messages, instructions, etc.) as defined by the policy in the owner's SCM playbook. This is captured by the message flow from step 770 to step 772, which may lead to an event notification 774 sent from a partner's management system 728 to a partner's SCM or SCM process 712. At step 776, the partner's SCM or SCM process 712 may now analyze the event and act accordingly, subject to an overall response time that is upper bounded, as defined by the response policy associated to the exception handling processes executed by exception handling process 249.

At step 778, the partner's management system 728 may now respond to the owner or SCM process 710 through the orchestrator 706 (e.g., exception handling process 249). This may be done by the partner's management system 728 directly, a partner's SCM or by a partner's SCM process 712. Exception handling process 249 may then notify, via messages 780-790, the owner of SCM process 710 as well as the SCM owner's enterprise management system 724. It may, using the messages 784 and 786, also notify the supplier's enterprise system 726 that triggered the SQA event.

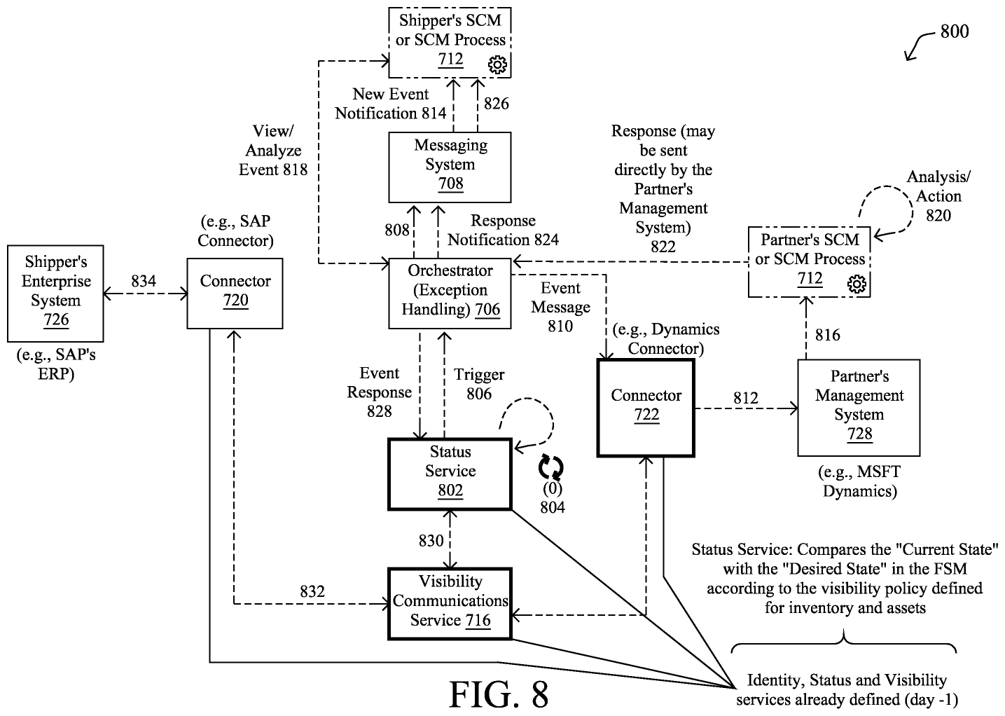

Turning now to FIG. 8, FIG. 8 illustrates an example flow diagram 800 for an exception handling service that includes a finite state machine. The diagram 800 includes an implementation of exception handling process 249 along with identity federation and visibility process 248, where status service 802 acts as input to orchestrator 706. Identity federation and visibility process 248 which can be used as a source for triggering different types of exception events. To this end, the identity federation and visibility process 248 may construct a finite state machine (FSM), included within the status service 802, for identifiable inventory items (or identifiable aggregates of inventory) as well as any physical assets that may be in transit along a supply chain. The FSM may model the expected state and location of an item along its journey across the supply chain, including the state transitions expected over time along the chain of custody.

The current state of the FSM can be compared to the desired state, to detect exceptions, which may comprise a monitoring loop 804 performed by status service 802. When an exception event is raised, exception handling process 249 may be alerted, which is then proceeds with steps as described with respected to FIG. 7. In FIG. 8, status service 802 may raise an alert including the ID of the partner that needs to be contacted. Orchestrator 706 may receive the event and identify the type of exception in step 806. The orchestrator may then automate the execution of corrective measures in a deterministic manner as in steps 808-822, similarly as done in FIG. 7. For example, at step 822, once the partner's management system 728 responds, exception handling process 249 may concurrently notify a shipper's SCM 712 in steps 824-826 as well as the shipper's enterprise system 726 in steps 828-834 (e.g., leveraging visibility communications service and associated connector to the shipper).

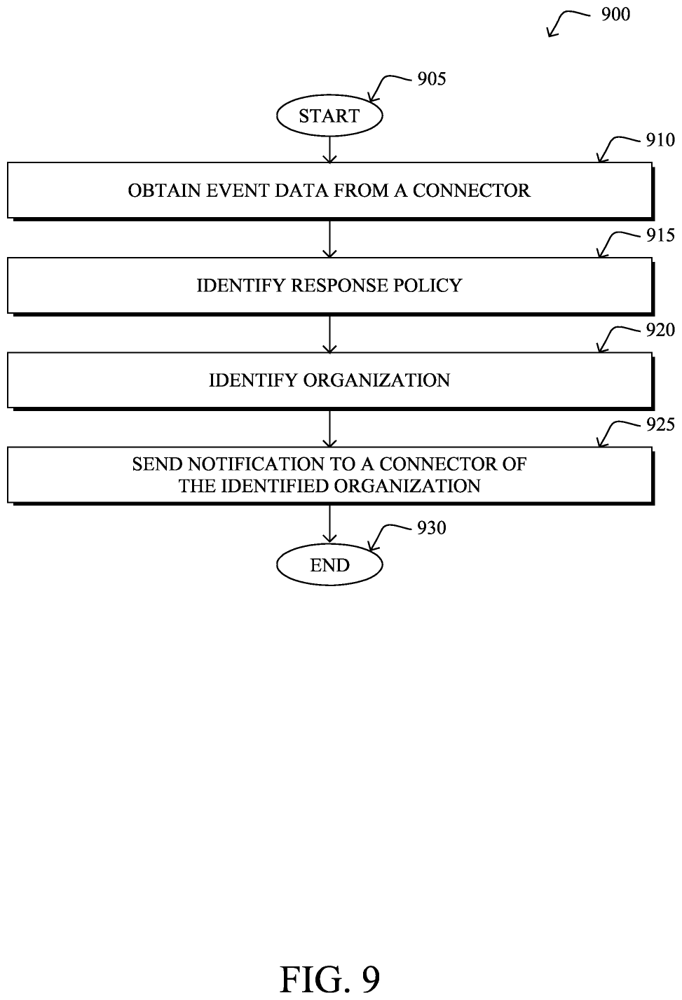

FIG. 9 illustrates an example simplified procedure for deterministic exception handling for item identity federation and visibility as a service, in accordance with one or more embodiments described herein. In various embodiments, a non-generic, specifically configured device (e.g., device 200) may perform procedure 900 by executing stored instructions (e.g., process 248 and process 249), to provide deterministic exception handling for item identity federation and visibility as a service. The procedure 900 may start at step 905, and continues to step 910, where, as described in greater detail above, a device may obtain, from a service connector of a first organization, event data for an event regarding shipment of one or more physical assets between organizations. For instance, the event data may specify a detected quality issue with the one or more physical assets. In some embodiments, the event may be detected when one or more environmental measurements for the one or more physical assets are outside of a predefined range. The service connector of the first organization may comprise a plugin configured to communicate with one or more devices of the first organization that monitor delivery status and environmental measurements of the one or more physical assets. As would be appreciated, the organizations may be participating in an identity federation and visibility as a service program, as described in greater detail herein to manage and monitor supply chain(s) across organizations.

At step 915, as detailed above, the device may identify, based on the event data, a response policy associated with the event. In some embodiments, the device may receive is the response policy from one or more of the organizations. Further, as would be appreciated, in some embodiments, the device may send a notification regarding the event to a supply chain manager. For example, organizations may each have their own policies governing or dictating how to handle how events, for example, spoilage of goods, delayed shipments, etc., are to be addressed within supply chain(s).

At step 920, the device may identify, based on the response policy, a second organization that is affected by the event. In some embodiments, the device may identify the second organization that is affected by the event by determining a number of the one or more physical assets affected by the event and corresponding locations of each of them.

At step 925, as detailed above, the device may send a notification regarding the event to a service connector of the second organization to initiate a corrective action for the event. In some embodiments, the notification to the service connector of the second organization comprises an indicator of the number of the one or more physical assets and indicators of the corresponding locations of each of them. In some embodiments, the device may include an indication of the corrective action in the notification based on the response policy. For instance, the corrective action may comprise causing the second organization to initiate shipment of a replacement for the one or more physical assets. In some embodiments, a plurality of notifications and/or messages (i.e., a back and forth of messages among a plurality of connectors) may be sent in addition to the notification, as part of a corrective action workflow. The plurality of notification sand/or messages may enable orchestration of a workflow (a set of messages and actions), constrained by time boundaries (i.e., deterministic in time) to satisfy requirements of a corrective action. Procedure 900 then ends at step 930.

It should be noted that while certain steps within procedure 900 may be optional as described above, the steps shown in FIG. 9 are merely examples for illustration, and certain other steps may be included or excluded as desired. Further, while a particular order of the steps is shown, this ordering is merely illustrative, and any suitable arrangement of the steps may be utilized without departing from the scope of the is embodiments herein.

The techniques described herein, therefore, allow for the unified identity and visibility of items across a supply chain. One of the main advantages of the techniques herein is that it requires neither a central identity federation provider, nor waiting for a network effect. Indeed, just a small group of parties/organizations can create a federation and start benefiting from its use, immediately. In addition, the techniques herein provide improved visibility of assets and inventory across multi-organization supply chains in a controlled way, such as by enabling policy-driven data exchange between supply chain members using trusted digital identities and enabling private identity federations between supply chain members. The techniques herein, by leveraging identity federation and visibility service(s) within a supply chain, enable both exception detection within a supply chain as well as exception handling (e.g., resolution and/or notification). That is, by automatically detecting exceptions of various types, the techniques herein are able to automatically implement corresponding corrective measures. For example, by monitoring connectors at suppliers and or shippers, events involving damaged goods or delayed goods can be either reported or detected, and remedies and/or notifications for each of these instances may be deployed.

While there have been shown and described illustrative embodiments for exception handling with a supply chain, it is to be understood that various other adaptations and modifications may be made within the intent and scope of the embodiments herein. For example, while specific types of identification technologies are described herein (e.g., RFID, BLE, etc.), the techniques herein are not limited as such and can be applied to any form of identification technology. Further, while the techniques herein are described primarily with respect to federating item identities and providing item visibility as well as exception handling across a supply chain, the techniques herein are not limited as such and can also be extended to federating workforce identity and visibility, connected asset identity and visibility, and the like.

The foregoing description has been directed to specific embodiments. It will be apparent, however, that other variations and modifications may be made to the described is embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

1. A method, comprising:
obtaining, by a device and from a service connector of a first organization, event data for an event regarding shipment of one or more physical assets between organizations, wherein the service connector of the first organization comprises a plugin configured to communicate with one or more devices of the first organization that monitor delivery status and environmental measurements of the one or more physical assets;
identifying, by the device and based on the event data, a response policy associated with the event;
identifying, by the device and based on the response policy, a second organization that is affected by the event; and
sending, by the device, a notification regarding the event to a service connector of the second organization to initiate a corrective action for the event.

2. The method as in claim 1, wherein the event data specifies a detected quality issue with the one or more physical assets.

3. The method as in claim 1, further comprising:
sending, by the device, a notification regarding the event to a supply chain manager.

4. The method as in claim 1, wherein identifying, by the device and based on the response policy, the second organization that is affected by the event comprises:
determining, by the device, a number of the one or more physical assets affected by the event and corresponding locations of each of them.

5. The method as in claim 4, wherein the notification to the service connector of the second organization comprises an indicator of the number of the one or more physical assets and indicators of the corresponding locations of each of them.

6. The method as in claim 1, wherein sending, by the device, the notification to initiate the corrective action for the event comprises:
including, by the device, an indication of the corrective action in the notification based on the response policy.

7. The method as in claim 6, wherein the corrective action comprises causing the second organization to initiate shipment of a replacement for the one or more physical assets.

8. The method as in claim 1, further comprising:
receiving, by the device, the response policy from one or more of the organizations.

9. The method as in claim 1, wherein the event is detected when one or more environmental measurements for the one or more physical assets are outside of a predefined range.

10. (canceled)

11. An apparatus, comprising:
one or more interfaces;
a processor coupled to the one or more interfaces and configured to execute one or more processes; and
a memory configured to store a process that is executable by the processor, the process when executed configured to:
obtain, from a service connector of a first organization, event data for an event regarding shipment of one or more physical assets between organizations, wherein the service connector of the first organization comprises a plugin configured to communicate with one or more devices of the first organization that monitor delivery status and environmental measurements of the one or more physical assets;
identify, based on the event data, a response policy associated with the event;
identify, based on the response policy, a second organization that is affected by the event; and
send a notification regarding the event to a service connector of the second organization to initiate a corrective action for the event.

12. The apparatus as in claim 11, wherein the event data specifies a detected quality issue with the one or more physical assets.

13. The apparatus as in claim 11, the process when executed further configured to:
send a notification regarding the event to a supply chain manager.

14. The apparatus as in claim 11, wherein to identify, based on the response policy, the second organization that is affected by the event comprises:
determining a number of the one or more physical assets affected by the event and corresponding locations of each of them.

15. The apparatus as in claim 14, wherein the notification to the service connector of the second organization comprises an indicator of the number of the one or more physical assets and indicators of the corresponding locations of each of them.

16. The apparatus as in claim 11, wherein to send the notification to initiate the corrective action for the event comprises:
including an indication of the corrective action in the notification based on the response policy.

17. The apparatus as in claim 16, wherein the corrective action comprises causing the second organization to initiate shipment of a replacement for the one or more physical assets.

18. The apparatus as in claim 11, the process when executed further configured to:
receive the response policy from one or more of the organizations.

19. The apparatus as in claim 11, wherein the event is detected when one or more environmental measurements for the one or more physical assets are outside of a predefined range.

20. A tangible, non-transitory, computer-readable medium storing program instructions that cause a device to execute a process comprising:
obtaining, by the device and from a service connector of a first organization, event data for an event regarding shipment of one or more physical assets between organizations, wherein the service connector of the first organization comprises a plugin configured to communicate with one or more devices of the first organization that monitor delivery status and environmental measurements of the one or more physical assets;
identifying, based on the event data, a response policy associated with the event;
identifying, based on the response policy, a second organization that is affected by the event; and
sending a notification regarding the event to a service connector of the second organization to initiate a corrective action for the event.
